(19) United States
(12) Patent Application Publication
(10) Pub. No.: US 2008/0313308 A1
(43) Pub. Date: Dec. 18, 2008

(54) Recasting a web page as a multimedia playlist

(76) Inventors: William K. Bodin, Austin, TX (US); David Jaramillo, Lake Worth, FL (US); Jesse W. Redman, Cedar Park, TX (US); Derral C. Thorson, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/763,599

(22) Filed: Jun. 15, 2007

(51) Int. Cl. G06F 15/16

(52) U.S. Cl. 709/219

(57) ABSTRACT

Computer-implemented methods, systems, and computer program products are described for recasting a web page as a multimedia playlist. Embodiments include receiving an identification of a web page to be recast; creating a plurality of multimedia files including content derived from the web page; and creating a playlist including the multimedia files.

### BACKGROUND OF THE INVENTION

1. Field of the Invention

The field of the invention is data processing, or, more specifically, methods, apparatus, and products for recasting a web page as a multimedia playlist.

2. Description of Related Art

Many users enjoy content in web pages served up by web servers. Such content typically must be viewed through conventional web browsers installed on larger computer devices. While some users have portable devices with micro-browsers that allow a user to conveniently view web pages on those portable devices, even more users have portable digital media players and digital media applications for rendering multimedia files.

### SUMMARY OF THE INVENTION

Computer-implemented methods, systems, and computer program products are described for recasting a web page as a multimedia playlist. Embodiments include receiving an identification of a web page to be recast; creating a plurality of multimedia files including content derived from the web page; and creating a playlist including the multimedia files.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for recasting a web page as a multimedia playlist according to embodiments of the present invention.

FIG. 2 sets forth a block diagram of automated computing machinery comprising an example of a computer useful as a proxy recasting server for recasting a web page as a multimedia playlist according to embodiments of the present invention.

FIG. 3 sets forth a functional block diagram of exemplary apparatus for recasting a web page as a multimedia playlist in a thick client architecture according to embodiments of the present invention.

FIG. 4 sets forth a flow chart illustrating an exemplary computer-implemented method for recasting a web page as a multimedia playlist.

FIG. 5 sets forth a flow chart illustrating an exemplary method for creating a playlist.

FIG. 6 sets forth a flow chart illustrating additional aspects of selecting display text as part of another exemplary method for creating a playlist.

FIG. 7 also sets forth a flow chart illustrating additional aspects of selecting display text as part of another exemplary method for creating a playlist.

FIG. 8 sets forth additional aspects of recasting a web page as a multimedia playlist according to embodiments of the present invention.

### DETAILED DESCRIPTION OF EXEMPLARY EMBODIMENTS

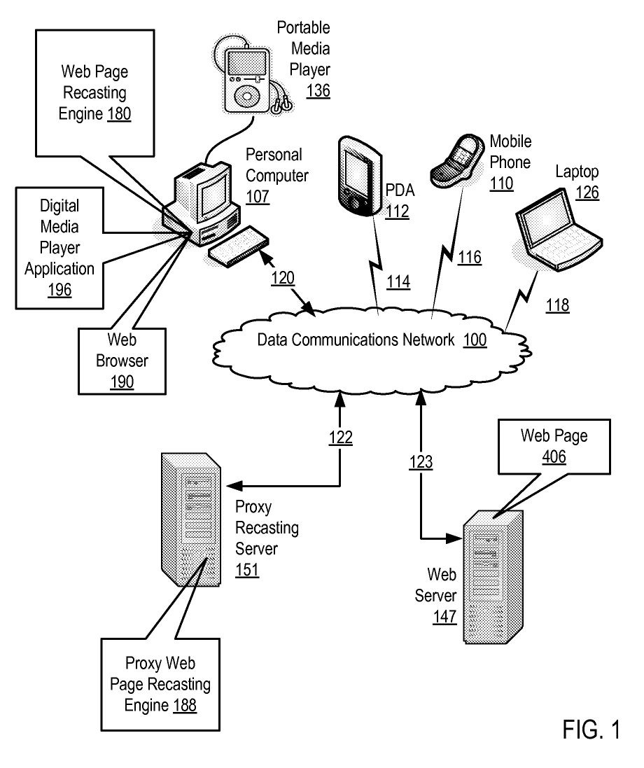

Exemplary methods, apparatus, and products for recasting a web page as a multimedia playlist are described with reference to the accompanying drawings, beginning with FIG. 1. FIG. 1 sets forth a network diagram illustrating an exemplary system for recasting a web page as a multimedia playlist according to embodiments of the present invention. Recasting a web page as a multimedia playlist according to embodiments of the present invention provides a user with the ability to receive the content of one or more web pages by rendering at the user's leisure the multimedia files of the playlist on one of a plurality of digital media player applications and devices.

Recasting a web page as a multimedia playlist in this example may be carried out by one of a plurality of client devices (107, 112, 110, and 118) or by a proxy recasting server (151). The client devices (107, 112, 110, and 118) and the proxy recasting server (151) of the system of FIG. 1 operate generally to carry out recasting a web page as a multimedia playlist by receiving an identification of a web page (406) to be recast; creating a plurality of multimedia files including content derived from the web page (406); and creating a playlist including the multimedia files.

The system of FIG. 1 includes a web server (147) connected for data communications through wireline connection (123) to network (100). The web server (147) may be any server that provides to client devices web pages, typically implemented as markup documents, that may be recast according to embodiments of the present invention. The web server (147) typically provides such web pages via a data communications protocol, HTTP, HDTP, WAP, or the like. That is, although the term ‘web’ is used to described the web server generally in this specification, there is no limitation of data communications between client devices and proxy recasting servers and the web server to HTTP alone. The web pages also may be implemented in any markup language as will occur to those of skill in the art.

The system of FIG. 1 includes example client devices:
personal computer (107) which is coupled for data communications to data communications network (100) through wireline connection (120) and also coupled for data communications such as synchronization with a portable media player (136), examples of portable media players include the iPod® from Apple and Creative Zen Vision from Creative labs,
personal digital assistant (‘PDA’) (112) which is coupled for data communications to data communications network (100) through wireless connection (114),
mobile telephone (110) which is coupled for data communications to data communications network (100) through wireless connection (116), and
laptop computer (126) which is coupled for data communications to data communications network (100) through wireless connection (118).

Each of the example client devices in the system of FIG. 1 includes a web browser for displaying web pages (406) as they are served up by a web server (147) coupled for data communications to data communications network (100) through wireline connection (123). Each of the example client devices in the system of FIG. 1 also includes a web page recasting engine, computer program instructions capable of receiving an identification of a web page (406) to be recast; creating a plurality of multimedia files including content derived from the web page; and creating a playlist including the multimedia files.

Each of the example client devices in the system of FIG. 1 also includes a digital media player application (196) capable of playback of the multimedia files of the playlist. The playlist may also be stored on and played back with the portable media player (136). Examples of digital media player applications include Music Match™, iTunes®, Songbird™, and others as will occur to those of skill in the art.

The web browser (190), the digital media player application (196) and the web page recasting engine (180) is shown in connection with only the personal computer (107) for clarity of explanation only. In fact, in the example of FIG. 1 each client device has installed upon it a web browser, digital media player application, and web page recasting engine according to embodiments of the present invention

The system of FIG. 1 also includes a proxy recasting server (151) including a proxy web page recasting engine (188), computer program instructions capable of receiving an identification of a web page (406) to be recast; creating a plurality of multimedia files including content derived from the web page; and creating a playlist including the multimedia files. A playlist recasting a web page created by proxy web page recasting engine (188) on a proxy recasting server (151) may be downloaded to one or more of the client devices (120, 114, 116, and 118) and played back using the digital media player application (196) installed on each client device.

As mentioned above, recasting a web page as a multimedia playlist according to the example of FIG. 1 may be carried on one or more client devices or on a proxy recasting server. A client device that itself contains its own web page recasting engine is said to implement a ‘thick client’, because the thick client device itself contains all the functionality needed to carry out recasting a web page as a multimedia playlist according to the present invention. A device that does not contain its own web page recasting engine is said to implement a ‘thin client’ because the thin client itself contains only a relatively thin layer of application software that obtains a playlist created by a proxy web page recasting engine on a proxy recasting server.

The system of FIG. 1 includes a data communications network (100) that connects the devices and servers for data communications. A data communications network useful for recasting a web page as a multimedia playlist according to embodiments of the present invention is a data communications network composed of a plurality of computers that function as data communications routers connected for data communications with packet switching protocols. Such a data communications network may be implemented with optical connections, wireline connections, or with wireless connections. Such a data communications network may include intranets, internets, local area data communications networks (‘LANs’), and wide area data communications networks (‘WANs’). Such a data communications network may implement, for example:
a link layer with the Ethernet™ Protocol or the Wireless Ethernet™ Protocol,
a data communications network layer with the Internet Protocol (‘IP’),
a transport layer with the Transmission Control Protocol (‘TCP’) or the User Datagram Protocol (‘UDP’),
an application layer with the HyperText Transfer Protocol (‘HTTP’), the Session Initiation Protocol (‘SIP’), the Real Time Protocol (‘RTP’), the Distributed Multimodal Synchronization Protocol (‘DMSP’), the Wireless Access Protocol (‘WAP’), the Handheld Device Transfer Protocol (‘HDTP’), the ITU protocol known as H.323, and
other protocols as will occur to those of skill in the art.

The arrangement of the client devices (107, 112, 110, and 126), web server (147), proxy recasting server (151), and the data communications network (100) making up the exemplary system illustrated in FIG. 1 are for explanation, not for limitation.

Data processing systems useful for recasting a web page as a multimedia playlist according to various embodiments of the present invention may include additional servers, routers, other devices, and peer-to-peer architectures, not shown in FIG. 1, as will occur to those of skill in the art. Data communications networks in such data processing systems may support many data communications protocols in addition to those noted above. Various embodiments of the present invention may be implemented on a variety of hardware platforms in addition to those illustrated in FIG. 1.

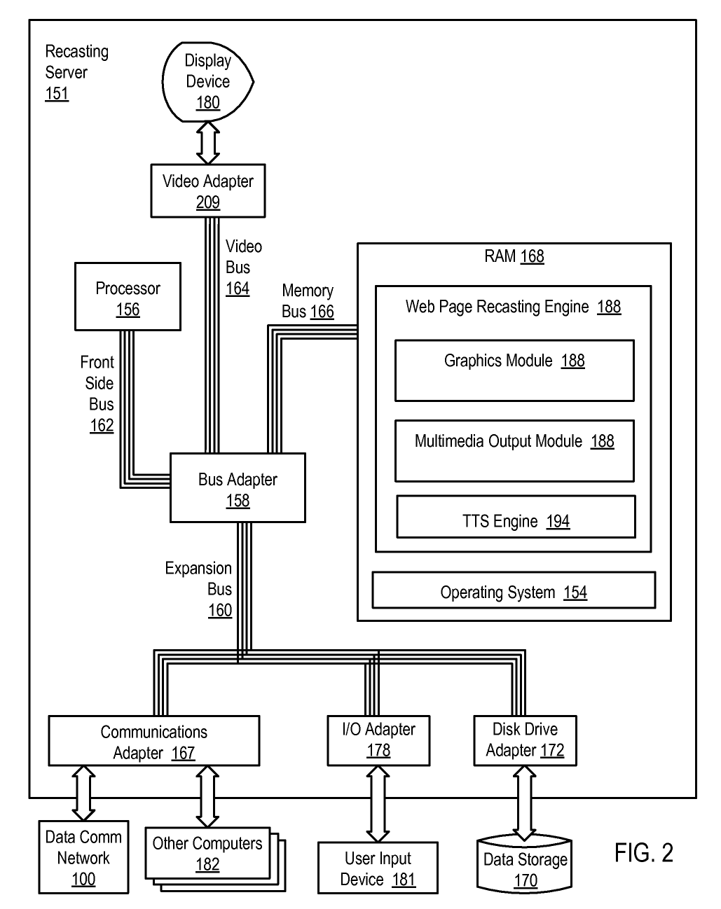

Recasting a web page as a multimedia playlist according to embodiments of the present invention in a thin client architecture may be implemented with one or more proxy recasting servers. For further explanation, therefore, FIG. 2 sets forth a block diagram of automated computing machinery comprising an example of a computer useful as a proxy recasting server (151) for recasting a web page as a multimedia playlist according to embodiments of the present invention. The proxy recasting server (151) of FIG. 2 includes at least one computer processor (156) or ‘CPU’ as well as random access memory (168) (‘RAM’) which is connected through a high speed memory bus (166) and bus adapter (158) to processor (156) and to other components of the proxy recasting server.

Stored in RAM (168) is a web page recasting engine (188), a module of computer program instructions capable of recasting a web page as a multimedia playlist by receiving an identification of a web page to be recast; creating a plurality of multimedia files including content derived from the web page; and creating a playlist including the multimedia files. The web page recasting engine (188) includes a multimedia output module (198) capable of a creating plurality of multimedia files including content derived from the web page including computer program instructions for retrieving the web page; determining a recast plan including the number of multimedia files to be included in the playlist and including a text selection policy; selecting display text of the web page; converting the selected display text to synthesized speech using the text-to-speech engine (194); recording the synthesized speech in a multimedia file; selecting from the web page an image to be associated with the synthesized speech; and storing the image in the same multimedia file.

Also stored in RAM (168) is an operating system (154). Operating systems useful in proxy recasting servers according to embodiments of the present invention include UNIX™, Linux™, Microsoft NT™, AIX™, IBM's i5/OS™, and others as will occur to those of skill in the art. Operating system (154), web page recasting engine (188), multimedia output module (188), and TTS Engine (194) in the example of FIG. 2 are shown in RAM (168), but many components of such software typically are stored in non-volatile memory also, for example, on a disk drive (170).

Proxy recasting server (151) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in proxy recasting servers according to embodiments of the present invention include the Intel Northbridge, the Intel Memory Controller Hub, the Intel Southbridge, and the Intel I/O Controller Hub. Examples of expansion buses useful in proxy recasting servers according to embodiments of the present invention include Industry Standard Architecture (‘ISA’) buses and Peripheral Component Interconnect (‘PCI’) buses.

Proxy recasting server (151) of FIG. 2 includes disk drive adapter (172) coupled through expansion bus (160) and bus adapter (158) to processor (156) and other components of the proxy recasting server (151). Disk drive adapter (172) connects non-volatile data storage to the proxy recasting server (151) in the form of disk drive (170). Disk drive adapters useful in proxy recasting servers include Integrated Drive Electronics (‘IDE’) adapters, Small Computer System Interface (‘SCSI’) adapters, and others as will occur to those of skill in the art. In addition, non-volatile computer memory may be implemented for a proxy recasting server as an optical disk drive, electrically erasable programmable read-only memory (so-called ‘EEPROM’ or ‘Flash’ memory), RAM drives, and so on, as will occur to those of skill in the art.

The example proxy recasting server of FIG. 2 includes one or more input/output (‘I/O’) adapters (178). I/O adapters in proxy recasting servers implement user-oriented input/output through, for example, software drivers and computer hardware for controlling output to display devices such as computer display screens, as well as user input from user input devices (181) such as keyboards and mice. The example proxy recasting server of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary proxy recasting server (151) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful according to embodiments of the present invention include modems for wired dial-up communications, Ethernet (IEEE 802.3) adapters for wired data communications network communications, and 802.11 adapters for wireless data communications network communications.

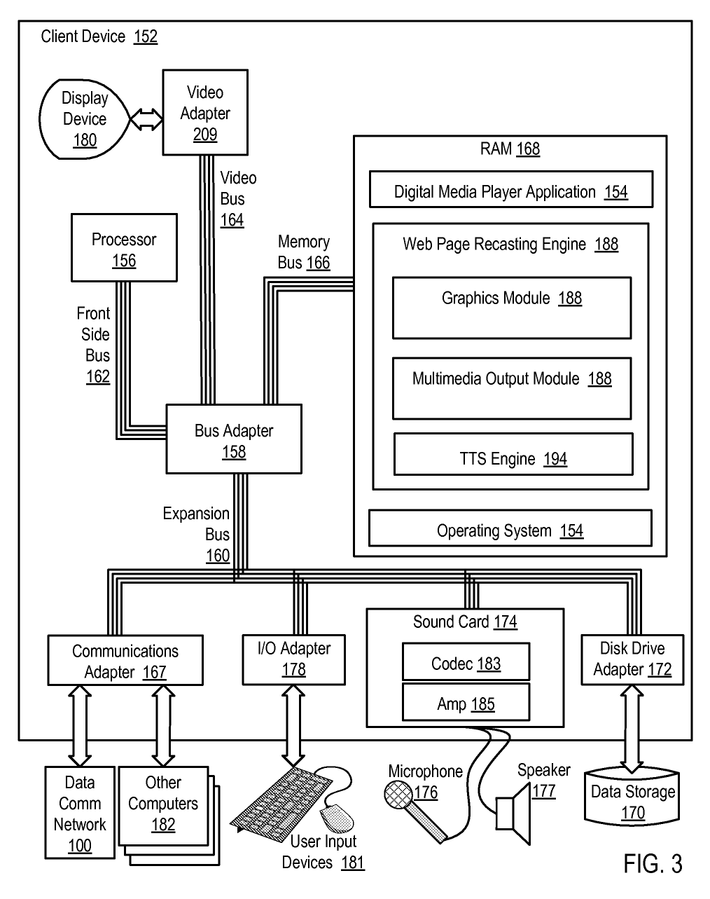

For further explanation, FIG. 3 sets forth a functional block diagram of exemplary apparatus for recasting a web page as a multimedia playlist in a thick client architecture according to embodiments of the present invention. The example of FIG. 3 includes a client device (152) having stored in RAM (168) is a web page recasting engine (188), a module of computer program instructions capable of recasting a web page as a multimedia playlist by receiving an identification of a web page to be recast; creating a plurality of multimedia files including content derived from the web page; and creating a playlist including the multimedia files in the playlist. The web page recasting engine (188) includes a multimedia output module (198) capable of creating plurality of multimedia files including content derived from the web page including computer program instructions for retrieving the web page; determining a recast plan including the number of multimedia files to be included in the playlist and including a text selection policy; selecting display text of the web page; converting the selected display text to synthesized speech using the text-to-speech engine (194); recording the synthesized speech in a multimedia file; selecting from the web page an image to be associated with the synthesized speech; and storing the image in the same multimedia file. Also stored in RAM (168) is a digital media player application capable of playing back the playlist.

Also stored in RAM (168) is an operating system (154). Operating systems useful in proxy recasting servers according to embodiments of the present invention include UNIX™, Linux™, Microsoft NT™, AIX™, IBM's i5/OS™, and others as will occur to those of skill in the art. Operating system (154), web page recasting engine (188), multimedia output module (188), and TTS Engine (194) in the example of FIG. 3 are shown in RAM (168), but many components of such software typically are stored in non-volatile memory also, for example, on a disk drive (170).

Client device (152) of FIG. 3 includes bus adapter (158), a computer hardware component that contains drive electronics for high speed buses, the front side bus (162), the video bus (164), and the memory bus (166), as well as drive electronics for the slower expansion bus (160). Examples of bus adapters useful according to embodiments of the present invention include the Intel Northbridge, the Intel Memory Controller Hub, the Intel Southbridge, and the Intel I/O Controller Hub. Examples of expansion buses useful according to embodiments of the present invention include Industry Standard Architecture (‘ISA’) buses and Peripheral Component Interconnect (‘PCI’) buses.

Client device (152) of FIG. 3 includes disk drive adapter (172) coupled through expansion bus (160) and bus adapter (158) to processor (156) and other components of the client device (152). Disk drive adapter (172) connects non-volatile data storage to the client device (152) in the form of disk drive (170). Disk drive adapters useful in client devices include Integrated Drive Electronics (‘IDE’) adapters, Small Computer System Interface (‘SCSI’) adapters, and others as will occur to those of skill in the art. In addition, non-volatile computer memory may be implemented an optical disk drive, electrically erasable programmable read-only memory (so-called ‘EEPROM’ or ‘Flash’ memory), RAM drives, and so on, as will occur to those of skill in the art.

The example client device of FIG. 3 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example client device of FIG. 3 includes also a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary client device (152) of FIG. 3 includes a sound card (174) including an amplifier (185) for producing the audio portion of the playback of the multimedia files of the playlist through a speaker (177).

The exemplary client device (152) of FIG. 3 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful according to embodiments of the present invention include modems for wired dial-up communications, Ethernet (IEEE 802.3) adapters for wired data communications network communications, and 802.11 adapters for wireless data communications network communications.

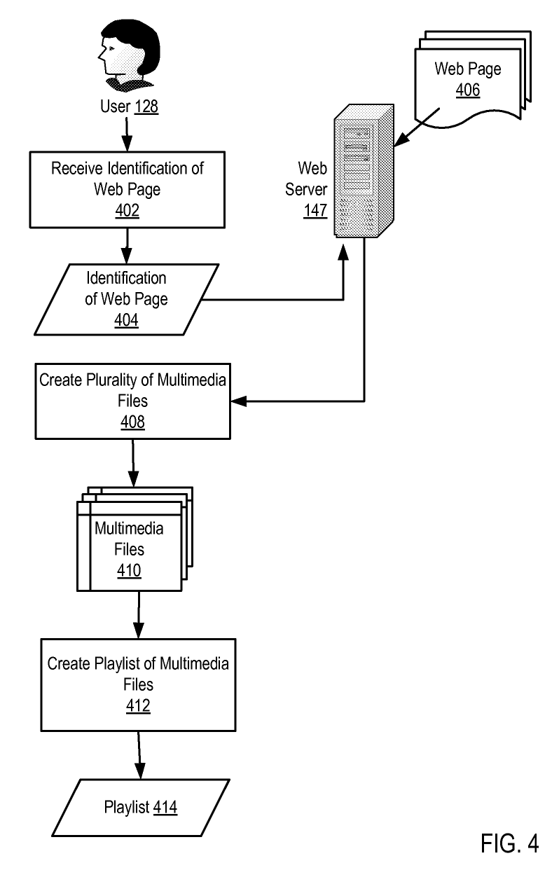

For further explanation, FIG. 4 sets forth a flow chart illustrating an exemplary computer-implemented method for recasting a web page as a multimedia playlist. A multimedia playlist is a collection of multimedia files associated through a data structure, text file or other type of structure. Typically, a multimedia playlist is implemented as a data structure or text file with pointers or references to each of the collection of multimedia files included in the playlist. A multimedia file is said to be ‘included’ in a playlist when a pointer or reference to that multimedia file is included in the data structure or text file implementing the playlist. The individual multimedia files of the playlist are typically ordered such that in at least some modes of playback the playlist may be played back by playing each multimedia file in a predetermined order.

A web page is a document, typically implemented as a markup document, served up by a web server and identified by a unique Uniform Resource Locator (‘URL’). Web pages are typically designed for being displayed in a web browser, computer program instructions for retrieving a web page from a URL, parsing the markup of a web page, and displaying as graphics or speech the content of the web page identified by the markup.

The method of FIG. 4 includes receiving (402) an identification (404) of a web page (406) to be recast. Receiving (402) an identification (404) of a web page (406) to be recast typically includes receiving a URL identifying a web page to be recast as a playlist of multimedia files. Such a URL may be received from a user, either human or process, by a web page recasting engine computer program instructions for recasting a web page as a playlist of multimedia files according to the present invention.

The method of FIG. 4 also includes creating (408) a plurality of multimedia files (410) including content derived from the web page (406). The content derived from the web page is typically display text or images of the web page to be included in the multimedia file for visual or speech rendering.

Examples of multimedia files useful in recasting web pages according to embodiments of the present invention include MPEG 3 (‘.mp3’) files, MPEG 4 (‘.mp4’) files, Advanced Audio Coding (‘AAC’) compressed files, Advances Streaming Format (‘ASF’) Files, WAV files, and many others as will occur to those of skill in the art. Creating (408) a plurality of multimedia files (410) including content derived from the web page (406) typically includes creating a multimedia file that is supported by a target portable media player upon which the playlist is to be rendered or a target digital media player application upon which the playlist is to be rendered.

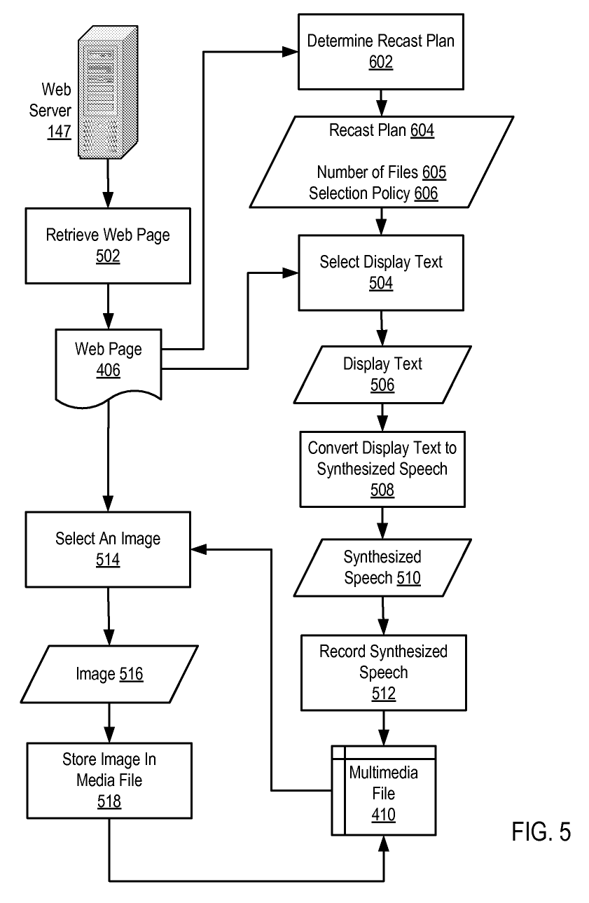

Creating (408) a plurality of multimedia files (410) including content derived from the web page (406) may be carried out by retrieving the web page; determining a recast plan including the number of multimedia files to be included in the playlist and including a text selection policy; selecting display text of the web page; converting the selected display text to synthesized speech; recording the synthesized speech in a multimedia file; selecting from the web page an image to be associated with the synthesized speech; and storing the image in the same multimedia file as described below with reference to FIG. 5.

The method of FIG. 4 also includes creating (412) a playlist (414) including (416) the multimedia files (410). Creating (412) a playlist (414) may be carried out by creating a data structure or text file with pointers or references to each of the collection of multimedia files included in the playlist. Creating (412) a playlist (414) may be carried out by invoking a function call of an application programming interface (‘API’) supporting the administration of the target digital media player application upon which the multimedia files are rendered.

For further explanation, FIG. 5 sets forth a flow chart illustrating an exemplary method for creating a playlist. The method of FIG. 5 includes retrieving (502) the web page (406). Retrieving (502) the web page (406) may be carried out by invoking the URL identifying the web page to be recast.

The method of FIG. 5 also includes determining (503) a recast plan (604) including the number (605) of multimedia files to be included in the playlist and including a text selection policy (606). A recast plan (604) is a dynamically created set of instructions for acquiring the content of the web page and including that content in the plurality of multimedia files of the playlist. The recast plan of FIG. 5 includes the number (605) of multimedia files to be included in playlist. The number of multimedia files may be determined in dependence upon a number of factors such as organization of the display text of the web page to be recast, the number of hyperlinks included in the web page to be recast, the quantity and quality of the content of the web page to be recast and may other factors as will occur to those of skill in the art.

The recast plan (604) of FIG. 5 also includes a text selection policy (606). A text selection policy (606) is a set of rules governing the selection of display text content of the web page to be recast for inclusion in a multimedia file of the playlist. Text selection policy may be used to select display text in dependence upon subject matter of the display text, font of the display text, location of the display text in the web page, markup associated with the display text in the web page, and many other factors as will occur to those of skill in the art.

Recast plans may vary according to the users for whom the web page is recast. Recasting web pages according to the present invention may therefore include receiving from a user one or more user preferences for determining a recast plan. Such user preferences may include a maximum number of multimedia files to include in the playlist, the data format of the multimedia files, content types for inclusion in the multimedia files of the playlist, an indication to also include the display text in and ID3 tag of the multimedia file such that it may be displayed on a display screen of a digital media player, and many other as will occur to those of skill in the art.

The method of FIG. 5 also includes selecting (504) display text (506) of the web page (406). Selecting display text of the web page may be carried out by reading the markup in the web page to identify display text, comparing the display text with the text selection policy and selecting display text that complies with the text selection policy.

The method of FIG. 5 also includes converting (508) the selected display text (506) to synthesized speech (510) and recording (512) the synthesized speech (510) in a multimedia file (410). Converting (508) the selected display text (506) to synthesized speech (510) and recording (512) the synthesized speech (510) in a multimedia file (410) may be carried out by processing the extracted text using a text-to-speech engine and then recording the speech produced by the text-speech-engine in the audio portion of a multimedia file.

Examples of speech engines capable of converting text to speech for recording in the audio portion of a multimedia file include, for example, IBM's ViaVoice® Text-to-Speech, Acapela Multimedia TTS, AT&T Natural Voices™ Text-to-Speech Engine, and Python's pyTTS class. Each of these text-to-speech engines is composed of a front end that takes input in the form of text and outputs a symbolic linguistic representation to a back end that outputs the received symbolic linguistic representation as a speech waveform.

Typically, speech synthesis engines operate by using one or more of the following categories of speech synthesis: articulatory synthesis, formant synthesis, and concatenative synthesis. Articulatory synthesis uses computational biomechanical models of speech production, such as models for the glottis and the moving vocal tract. Typically, an articulatory synthesizer is controlled by simulated representations of muscle actions of the human articulators, such as the tongue, the lips, and the glottis. Computational biomechanical models of speech production solve time-dependent, 3-dimensional differential equations to compute the synthetic speech output. Typically, articulatory synthesis has very high computational requirements, and has lower results in terms of natural-sounding fluent speech than the other two methods discussed below.

Formant synthesis uses a set of rules for controlling a highly simplified source-filter model that assumes that the glottal source is completely independent from a filter which represents the vocal tract. The filter that represents the vocal tract is determined by control parameters such as formant frequencies and bandwidths. Each formant is associated with a particular resonance, or peak in the filter characteristic, of the vocal tract. The glottal source generates either stylized glottal pulses or periodic sounds and generates noise for aspiration. Formant synthesis generates highly intelligible, but not completely natural sounding speech. However, formant synthesis has a low memory footprint and only moderate computational requirements.

Concatenative synthesis uses actual snippets of recorded speech that are cut from recordings and stored in an inventory or voice database, either as waveforms or as encoded speech. These snippets make up the elementary speech segments such as, for example, phones and diphones. Phones are composed of a vowel or a consonant, whereas diphones are composed of phone-to-phone transitions that encompass the second half of one phone plus the first half of the next phone. Some concatenative synthesizers use so-called demi-syllables, in effect applying the diphone method to the time scale of syllables. Concatenative synthesis then strings together, or concatenates, elementary speech segments selected from the voice database, and, after optional decoding, outputs the resulting speech signal. Because concatenative systems use snippets of recorded speech, they have the highest potential for sounding like natural speech, but concatenative systems require large amounts of database storage for the voice database.

The method of FIG. 5 also includes selecting (514) from the web page (406) an image (516) to be associated with the synthesized speech (510). An image may be selected in dependence upon markup identifying the image as related to the display text, the images location in the web page, or in other ways as will occur to those of skill in the art.

The method of FIG. 5 also includes storing (518) the image (516) in the same multimedia file (410). Storing (518) the image (516) in the same multimedia file (410) may be carried out by storing the image in a header such as for example an ID3v2 tag prepended to the audio portion of the multimedia file. An ID3v2 tag, for example, is designed to provide a container for metadata associated with the multimedia file but may also be used to include information useful in recasting a web page as a playlist of multimedia files. An ID3v2 tag includes one or more frames supporting the inclusion of text, images, files, and other information. ID3v2 tags are flexible and expandable because parsers that do not support specific functions of an ID3v2 tag will ignore those functions. ID3v2 supports Unicode thereby providing the ability to include extracted text of many different languages. The maximum tag size of an ID3v2 tag is typically 256 megabytes and maximum frame size is typically 16 megabytes.

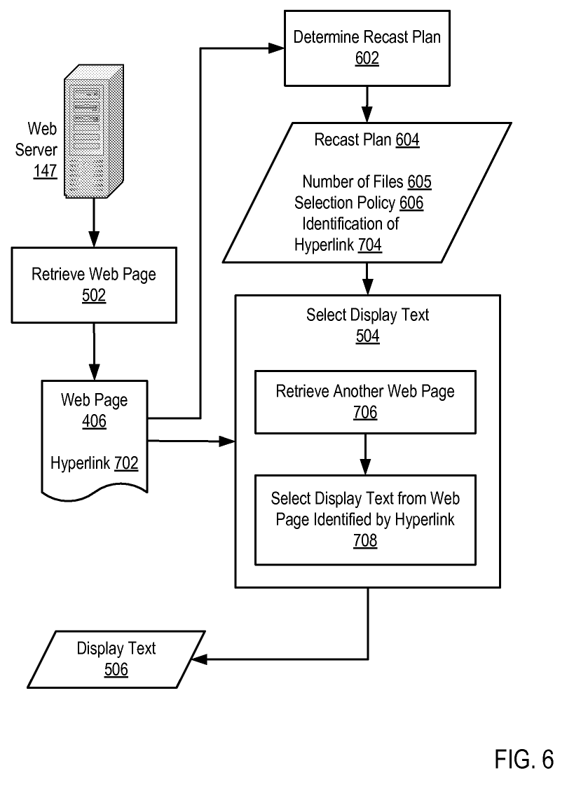

Selecting display text as part of creating a playlist may be carried out in further dependence upon additional criteria. For further explanation, FIG. 6 sets forth a flow chart illustrating additional aspects of selecting display text as part of another exemplary method for creating a playlist. The method of FIG. 6 is similar to the method of FIG. 5 in that the method of FIG. 6 includes retrieving (502) the web page (406); determining (503) a recast plan (604) including the number (605) of multimedia files to be included in the playlist and including a text selection policy (606); selecting (504) display text (506) of the web page (406). For ease of explanation, the example of FIG. 6 does not illustrate the steps of converting the selected display text to synthesized speech; recording the synthesized speech in a multimedia file; selecting from the web page an image to be associated with the synthesized speech; and storing the image in the same multimedia file.

FIG. 6 differs from the method of FIG. 5 in that the recast plan (604) of FIG. 6 includes identifications (704) of hyperlinks (702) in the web page (406) and selecting (504) display text (506) of the web page (406) according to the method of FIG. 6 also includes retrieving (706) another web page (not shown in FIG. 6) identified by the hyperlink (702). A hyperlink is a reference to another web page often displayed in highlighting or underlining in the web page and identified in markup in the web page. Hyperlinks provide references to additional content in a web page and therefore such additional content may be included in the playlist recasting the web page.

Selecting (504) display text (506) of the web page (406) according to the method of FIG. 6 therefore also includes selecting (708) display text (506) from another web page (not shown in FIG. 6) that complies with the text selection policy (606). Selecting (708) display text (506) from another web page (not shown in FIG. 6) that complies with the text selection policy (606) provides the recast of the web page content referenced in the that web page that complies with the text selection policy but that is contained within another web page. Selecting (708) display text (506) from another web page (not shown in FIG. 6) that complies with the text selection policy (606) allows the recasting of some or all of an entire web sites in the recasting of a single web page.

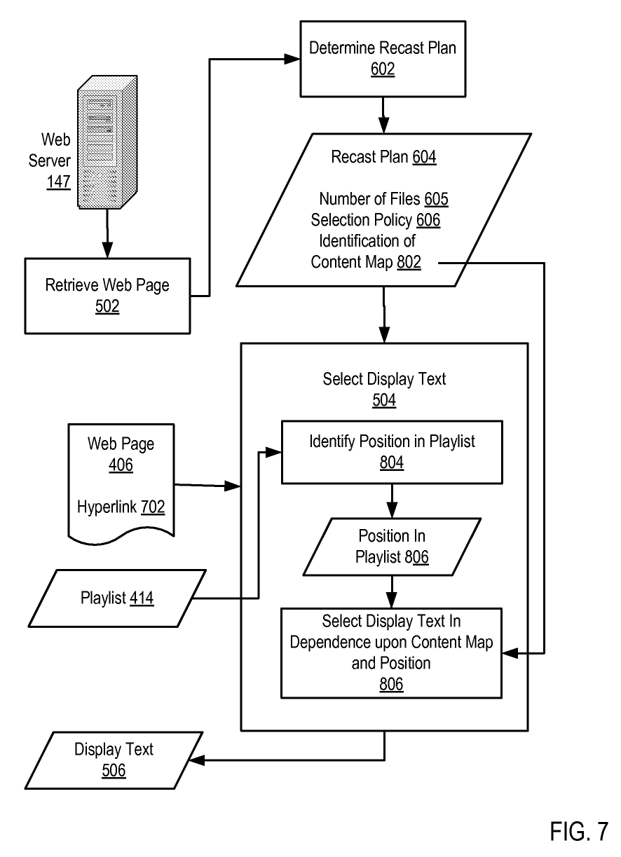

As mentioned above, selecting display text as part of creating a playlist may be carried out in further dependence upon additional criteria. For further explanation, FIG. 7 also sets forth a flow chart illustrating additional aspects of selecting display text as part of another exemplary method for creating a playlist. The method of FIG. 7 is similar to the methods of FIG. 5 and FIG. 6 in that the method of FIG. 6 includes retrieving (502) the web page (406); determining (503) a recast plan (604) including the number (605) of multimedia files to be included in the playlist and including a text selection policy (606); selecting (504) display text (506) of the web page (406). For ease of explanation, the example of FIG. 7 does not illustrate the steps of converting the selected display text to synthesized speech; recording the synthesized speech in a multimedia file; selecting from the web page an image to be associated with the synthesized speech; and storing the image in the same multimedia file.

FIG. 7 differs from the method of FIG. 6 and FIG. 5 in that the recast plan (604) of FIG. 7 also includes a content map (802) associating identifications of content with particular positions in a playlist of multimedia files and selecting (504) display text (506) of the web page (406) according to the method of FIG. 7 includes identifying (804) a position (806) of the multimedia file in the playlist (414) and selecting (806) display text (506) in accordance with the content map (802) and the position of the multimedia file in the playlist (414). A content map provides a vehicle for ordering and prioritizing content derived from the web page. The content map may be implemented as a set of rules designed to order or prioritize display text of a web site. Such display text may be ordered or prioritized and therefore placed in an earlier position in the playlist in dependence upon the location of the display text in the web page, the size and font of the display text in the web page, the subject matter of the content, and many others as will occur to those of skill in the art.

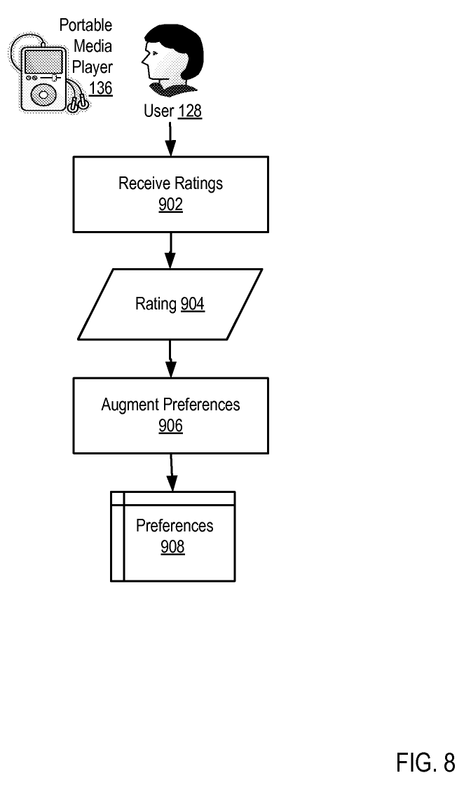

As mentioned above, web pages may be recast in dependence upon user preferences. Such preferences may advantageously be augmented by users real time using the rating systems supported by many types of digital media player applications. For example, the iPod® digital audio player and the iTunes® digital audio player application available from Apple® support a five-star rating system that provides assigning to content one of five ratings: one star, two stars, three stars, four stars, or five stars. Such ratings assigned to a multimedia file in a playlist may be used to augment user preferences for recasting web pages in accordance with the present invention. For further explanation, therefore, FIG. 8 sets forth additional aspects of recasting a web page as a multimedia playlist according to embodiments of the present invention. The method of FIG. 8 includes receiving (902) on a playback device (136) from the user (128) one or more ratings (904) for one or more multimedia files in the playlist. In the example of FIG. 8 the playback device is illustrated as a portable media player (136) that supports ratings, such as, for example, the iPod® digital audio player.

The method of FIG. 8 also includes augmenting (906) the preferences (908) established for determining a recast plan in dependence upon the ratings (904). Augmenting (906) the preferences (908) established for determining a recast plan in dependence upon the ratings (904) may be carried out by receiving the rating associated with the one or more multimedia files in playlist upon, for example, synchronization of a playback device and digital media player application, and inferring an instruction to augment user preferences for recasting web pages in dependence upon those ratings. Inferring an instruction to augment user preferences for recasting web pages in dependence upon those ratings may be carried out according to augmentation rules designed to parse the ratings of the individual multimedia files and select one or more predetermined instructions to augment user preferences.

For further explanation of augmenting (906) the preferences (908) established for determining a recast plan in dependence upon the ratings (904) consider, for example the following use case. A user renders playback of a playlist of multimedia files that recasts a web page whose subject matter is guitars. Upon playback, the user rates each multimedia file in the playlist with a rating of ‘1’ (the highest rating possible) except for one multimedia file which is rated a ‘5’ (the lowest rating possible). The multimedia files rated ‘1’ contains synthesized speech created from different articles of web pages describing different guitar playing styles. The multimedia file rated ‘5’ contains synthesized speech created from advertisement text located on one side in the web site. Augmenting (906) the preferences (908) established for determining a recast plan according to the example of FIG. 8 in this use case may include augmenting preferences to exclude all advertisement display text from any future playlists.

Exemplary embodiments of the present invention are described largely in the context of a fully functional computer system for recasting a web page as a multimedia playlist. Readers of skill in the art will recognize, however, that the present invention also may be embodied in a computer program product disposed on computer-readable signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method for recasting a web page as a multimedia playlist, the method comprising:
receiving an identification of a web page to be recast;
creating a plurality of multimedia files including content derived from the web page; and
creating a playlist including the multimedia files.

2. The method of claim 1 wherein creating a playlist further comprises:
retrieving the web page;
determining a recast plan including the number of multimedia files to be included in the playlist and including a text selection policy;
selecting display text of the web page;
converting the selected display text to synthesized speech;
recording the synthesized speech in a multimedia file;
selecting from the web page an image to be associated with the synthesized speech; and
storing the image in the same multimedia file.

3. The method of claim 2 wherein the recast plan includes identifications of hyperlinks in the web page and selecting display text of the web page further comprises:
retrieving another web page identified by the hyperlink; and
selecting display text from the another web page that complies with the text selection policy.

4. The method of claim 2 wherein the recast plan also includes a content map associating identifications of content with particular positions in the playlist of multimedia files; and
selecting display text of the web page further comprises:
identifying a position of the multimedia file in the playlist; and
selecting display text in accordance with the content map and the position of the multimedia file in the playlist.

5. The method of claim 1 further comprising receiving from a user preferences for determining a recast plan for recasting a web page as a multimedia playlist.

6. The method of claim 5 further comprising:
receiving on a playback device from the user one or more ratings for one or more multimedia files in the playlist;
augmenting the preferences established for determining a recast plan in dependence upon the ratings.

7. An system for recasting a web page as a multimedia playlist, the system comprising:
means for receiving an identification of a web page to be recast;
means for creating a plurality of multimedia files including content derived from the web page; and
means for creating a playlist including the multimedia files.

8. The system of claim 7 wherein means for creating a playlist further comprise:
means for retrieving the web page;
means for determining a recast plan including the number of multimedia files to be included in the playlist and including a text selection policy;
means for selecting display text of the web page;
means for converting the selected display text to synthesized speech;
means for recording the synthesized speech in a multimedia file;
means for selecting from the web page an image to be associated with the synthesized speech; and
means for storing the image in the same multimedia file.

9. The system of claim 8 wherein the recast plan includes identifications of hyperlinks in the web page and means for selecting display text of the web page further comprise:
means for retrieving another web page identified by the hyperlink; and
means for selecting display text from the another web page that complies with the text selection policy.

10. The system of claim 8 wherein the recast plan also includes a content map associating identifications of content with particular positions in the playlist of multimedia files and means for selecting display text of the web page further comprise:
means for identifying a position of the multimedia file in the playlist; and
means for selecting display text in accordance with the content map and the position of the multimedia file in the playlist.

11. The system of claim 7 further comprising means for receiving from a user preferences for determining a recast plan for recasting a web page as a multimedia playlist.

12. The system of claim 11 further comprising:
means for receiving on a playback device from the user one or more ratings for one or more multimedia files in the playlist;
means for augmenting the preferences established for determining a recast plan in dependence upon the ratings.

13. An computer program product for recasting a web page as a multimedia playlist, the computer program product disposed upon a computer-readable, signal-bearing medium, the computer program product comprising computer program instructions capable of:
receiving an identification of a web page to be recast;
creating a plurality of multimedia files including content derived from the web page; and
creating a playlist including the multimedia files.

14. The computer program product of claim 13 wherein computer program instructions capable of creating a playlist further comprise computer program instructions capable of:
retrieving the web page;
determining a recast plan including the number of multimedia files to be included in the playlist and including a text selection policy;
selecting display text of the web page;
converting the selected display text to synthesized speech;
recording the synthesized speech in a multimedia file;
selecting from the web page an image to be associated with the synthesized speech; and
storing the image in the same multimedia file.

15. The computer program product of claim 14 wherein the recast plan includes identifications of hyperlinks in the web page and computer program instructions capable of selecting display text of the web page further comprise computer program instructions capable of:
retrieving another web page identified by the hyperlink; and
selecting display text from the another web page that complies with the text selection policy.

16. The computer program product of claim 14 wherein the recast plan also includes a content map associating identifications of content with particular positions in the playlist of multimedia files and computer program instructions capable of selecting display text of the web page further comprise computer program instructions capable of:
identifying a position of the multimedia file in the playlist; and
selecting display text in accordance with the content map and the position of the multimedia file in the playlist.

17. The computer program product of claim 13 further comprising computer program instructions capable of receiving from a user preferences for determining a recast plan for recasting a web page as a multimedia playlist.

18. The computer program product of claim 17 further comprising computer program instructions capable of:
receiving on a playback device from the user one or more ratings for one or more multimedia files in the playlist;
augmenting the preferences established for determining a recast plan in dependence upon the ratings.

19. The computer program product of claim 13 wherein the computer-readable, signal-bearing medium comprises a recordable medium.

20. The computer program product of claim 13 wherein the computer-readable, signal-bearing medium comprises a transmission medium.
